(19) United States
(12) Patent Application Publication
(10) Pub. No.: US 2023/0303108 A1
(43) Pub. Date: Sep. 28, 2023

(54) RECOMMENDATION DEVICE AND RECOMMENDATION METHOD

(71) Applicant: HONDA MOTOR CO., LTD., Tokyo (JP)

(72) Inventors: Shinya Yasuhara, Tokyo (JP); Keigo Nakada, Tokyo (JP); Yusuke Inoue, Tokyo (JP); Daisuke Ide, Tokyo (JP); Yujiro Kita, Tokyo (JP); Adil Gupta, Tokyo (JP); Ko Uchida, Tokyo (JP)

(21) Appl. No.: 18/163,447

(22) Filed: Feb. 2, 2023

(30) Foreign Application Priority Data
Mar. 28, 2022 (JP) 2022-051723

(51) Int. Cl. B60W 50/14; G06Q 30/0207

(52) U.S. Cl. CPC B60W 50/14; G06Q 30/0207; B60W 2556/45; B60W 2050/146; B60W 2556/10

(57) ABSTRACT

A recommendation device is a device that recommends a driver assistance function available for a user who is driving a vehicle. The recommendation device includes: an information collection unit configured to collect information related to the use of the driver assistance function in a plurality of the vehicles; an aggregation unit configured to aggregate the information related to the use collected by the information collection unit; a prescribed area specification unit configured to specify, among areas where the driver assistance function is expected to be used, a prescribed area where an aggregation result acquired by the aggregation unit corresponds to a prescribed condition; and a recommendation unit configured to output recommendation information for recommending the prescribed area and the driver assistance function expected to be used in the prescribed area in an associated manner.

### INCORPORATION BY REFERENCE

The present application claims priority under 35 U.S.C. § 119 to Japanese Patent Application No. 2022-051723 filed on Mar. 28, 2022. The content of the application is incorporated herein by reference in its entirety.

### BACKGROUND OF THE INVENTION

### Field of the Invention

The present invention relates to a recommendation device and a recommendation method.

### Description of the Related Art

Japanese Patent Laid-Open No. 2020-165688 discloses a technology that superimposes and displays, on a map screen, display information regarding recommendation levels of autonomous driving based on the histories related to execution of autonomous driving in a plurality of vehicles. In Japanese Patent Laid-Open No. 2020-165688, it is disclosed that the technology makes it possible to display the recommendation level of autonomous driving in an easy-to-understand manner and to improve the convenience for the users of autonomous cars.

For example, there is only a poor record of autonomous driving conducted on a newly opened road. Furthermore, the conventional technology faces such issues that autonomous driving is not likely to be recommended for places with a poor record of autonomous driving, and that autonomous driving may not be recommended to users even for places where it is supposedly expected to conduct autonomous driving. Furthermore, due to such issues, it is difficult to accumulate a record of autonomous driving conducted in such places.

Note that such issues are not limited only to autonomous driving but also to cases of recommending other driver assistance functions.

It is an object of the present invention to provide a recommendation device and a recommendation method capable of offering a recommendation for an area where there is only a poor use record of a driver assistance function in a plurality of vehicles.

### SUMMARY OF THE INVENTION

One aspect of the present invention is a recommendation device recommending a driver assistance function available for a user who is driving a vehicle, and the recommendation device includes: an information collection unit configured to collect information related to use of the driver assistance function in a plurality of the vehicles; an aggregation unit configured to aggregate the information related to the use collected by the information collection unit; a prescribed area specification unit configured to specify, among areas where the driver assistance function is expected to be used, a prescribed area where an aggregation result acquired by the aggregation unit corresponds to a prescribed condition; and a recommendation unit configured to output recommendation information that recommends the prescribed area and the driver assistance function expected to be used in the prescribed area in an associated manner.

The recommendation device according to one aspect of the present invention includes a moving route acquisition unit configured to acquire a moving route of the vehicle driven by a target user of the recommendation, in which the prescribed area recommended by the recommendation unit is an area where the moving route passes through.

In the recommendation device according to one aspect of the present invention, the moving route is a travel route in one cycle of past or future driving cycles of the vehicle.

The recommendation device according to one aspect of the present invention includes an incentive giving unit configured to give an incentive to a target user of the recommendation, when the target user uses the driver assistance function recommended by the recommendation information.

In the recommendation device according to one aspect of the present invention, the incentive giving unit gives the incentive, when the user evaluates the driver assistance function.

One aspect of the present invention is a recommendation method used in a recommendation device that recommends a driver assistance function available for a user who is driving a vehicle, and the recommendation method includes: collecting information related to use of the driver assistance function in a plurality of the vehicles; aggregating the collected information related to the use; specifying, among areas where the driver assistance function is expected to be used, a prescribed area where an aggregation result of the information related to the use corresponds to a prescribed condition; and outputting recommendation information that recommends the prescribed area and the driver assistance function expected to be used in the prescribed area in an associated manner.

According to one aspect of the present invention, it is possible to offer a recommendation for an area where there is only a poor use record of the driver assistance function in a plurality of vehicles.

### BRIEF DESCRIPTION OF THE DRAWINGS

FIG. 1 is a diagram showing a configuration of a recommendation system according to an embodiment of the present invention;

FIG. 2 is a diagram showing a functional configuration of a vehicle system;

FIG. 3 is a diagram showing a functional configuration of a recommendation server;

FIG. 4 is a diagram showing a functional configuration of a client device;

FIG. 5 is a flowchart showing recommendation processing of the recommendation server; and

FIG. 6 is a diagram showing an example of display based on recommendation information.

### DETAILED DESCRIPTION OF THE PREFERRED EMBODIMENT

Hereinafter, an embodiment of the present invention will be described with reference to the accompanying drawings.

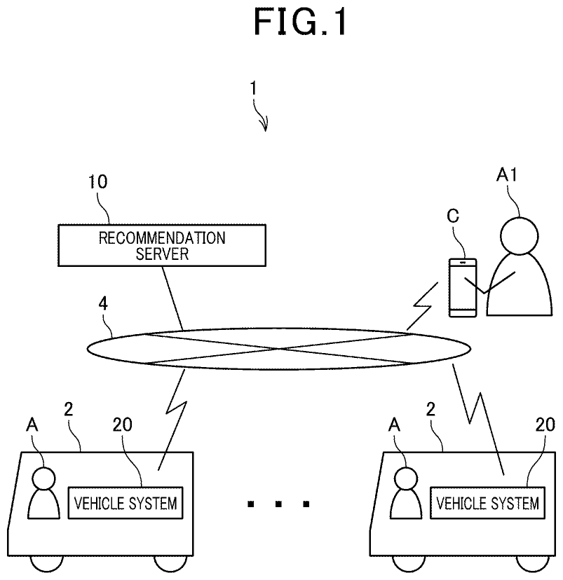

FIG. 1 is a diagram showing a configuration of a recommendation system 1 according to the embodiment.

The recommendation system 1 is a system that provides a recommendation service to a client device C through a telecommunication line 4 such as the Internet. The recommendation service according to the embodiment is a service for recommending, to a user A who is driving the vehicle 2, driver assistance functions that are available in a vehicle 2 and areas on a map where the driver assistance functions are expected to be used in an associated manner.

The driver assistance functions are various kinds of functions for assisting the user A to drive the vehicle 2, and examples thereof may be an autonomous driving function, an automated following function, an anti-glare function, an adaptive cruise control function, an auto-braking operation function, and the like.

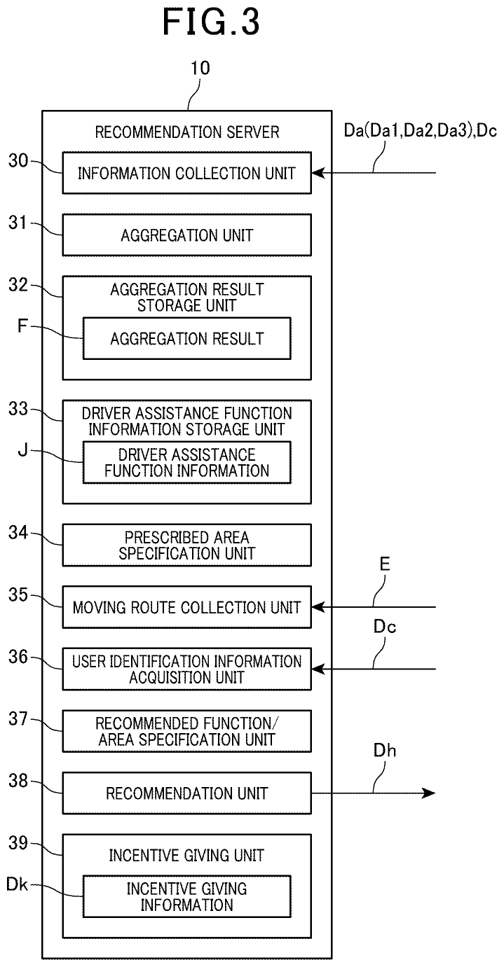

Furthermore, the recommendation system 1 according to the embodiment recommends, among areas where the use of the driver assistance function is expected, the driver assistance function targeted at a prescribed area where an aggregation result F (FIG. 3) of information related to the use of the driver assistance function in a plurality of vehicles 2 corresponds to a prescribed condition.

This makes it possible to recommend the driver assistance function in accordance with the use records of the driver assistance function in a plurality of vehicles 2 in each of the areas. Therefore, it is possible to encourage a target user A1 that is a recommendation target to use the driver assistance function also in a place where there is only a poor use record of the driver assistance function such as a newly opened road, for example. Moreover, it is also possible to accumulate the use record of the driver assistance function on such a road more quickly.

Furthermore, the recommendation system 1 according to the embodiment selects the prescribed area from the areas where a moving route E of the vehicle 2 driven by the target user A1 passes through. The moving route E may be a travel route in one cycle of past or future driving cycles of the vehicle 2. Thereby, the target user A1 can do review and preparation of the prescribed area and the driver assistance function expected to be used in the prescribed area for the past travel routes or the future travel routes.

Note that the driving cycle is a period where the user A uses the vehicle 2 for moving to a destination point from a departure point and, for example, a period from an operation of a start switch for starting a power source of the vehicle 2 to a next reoperation is set as one cycle may be used.

Next, the configuration related to the recommendation system 1 according to the embodiment will be described in detail.

As shown in FIG. 1, the recommendation system 1 includes a recommendation server 10 for providing the recommendation service described above. The recommendation server 10 has: an information collection function for collecting use history information Da from a plurality of vehicles 2 via the telecommunication line 4; an aggregation function for aggregating the use history information Da; a recommendation function for recommending the driver assistance function to the target user A1; and an incentive giving function for giving an incentive to the target user A1 who has used the driver assistance function. Note that the specific functional configuration of the recommendation server 10 will be described later.

The use history information Da is information related to the history of the driver assistance functions used in the vehicle 2 by the user A. The vehicle 2 includes a vehicle system 20 that has functions of recording and transmitting the use history information Da.

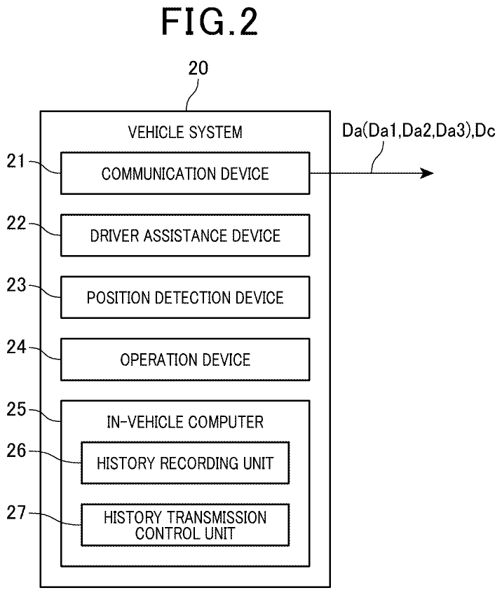

FIG. 2 is a diagram showing a functional configuration of the vehicle system 20.

The vehicle system 20 is a system that includes one or a plurality of in-vehicle devices loaded on the vehicle 2, and includes a communication device 21, a driver assistance device 22, a position detection device 23, an operation device 24, and an in-vehicle computer 25.

The communication device 21 is a device that has a transmitter and a receiver and communicates with the recommendation server 10 via the telecommunication line 4.

The driver assistance device 22 is a device that is configured with a computer comprising a processor and a memory and implements one or a plurality of driver assistance functions described above. Note that the vehicle system 20 may include a plurality of driver assistance devices 22.

The position detection device 23 is a device that detects the current position of the vehicle 2. The position detection device 23 according to the embodiment includes a GNSS (Global Navigation Satellite System) receiver that receives positioning signals transmitted from a plurality of positioning satellites, and specifies the position based on those positioning signals.

The operation device 24 is a device that receives operations of the user A, and it is a button, a touch panel, or the like. The operation device 24 is also used as evaluation input means where the user A who has used the driver assistance function inputs an evaluation regarding the usability and the like of the driver assistance function.

The in-vehicle computer 25 includes: a processor such as a CPU (Central Processing Unit) or an MPU (Micro-Processing Unit); a memory device (also referred to as a main memory device) such as a ROM (Read Only Memory) or a RAM (Random Access Memory); a storage device (also referred to as a subsidiary storage device) such as an HDD (Hard Disk Drive) or an SSD (Solid State Drive); and an interface circuit for connecting various peripheral devices (the communication device 21, the driver assistance device 22, the position detection device 23, the operation device 24, and the like).

Then, the functions related to recording and transmission of the use history information Da are implemented through executing a computer program stored in the memory device or the storage device by the processor.

Specifically, the in-vehicle computer 25 includes, as the functional configuration, a history recording unit 26 and a history transmission control unit 27.

The history recording unit 26 records, in the use history information Da, the information related to the use history of the user A regarding the driver assistance functions. The information related to the use history contains at least used function information Da1 indicating the used drive assistance function, used position information Da2 indicating the position of the vehicle 2 when the driver assistance function is used, and user evaluation information Da3 indicating the evaluation for the driver assistance function made by the user A. In addition to those, the information related to the use history may contain the date/time (date and time) at which the driver assistance function is used, information related to driving the vehicle 2 and surrounding environment (car speed, road congestion condition, presence of obstacles around, and the like) thereof. Such information related to driving and surrounding environment can be acquired from adequate in-vehicle devices (in-vehicle camera, vehicle control ECU (Electronic Control Unit), and the like) provided to the vehicle 2.

The history transmission control unit 27 executes control for transmitting the use history information Da to the recommendation server 10 from the communication device 21. Furthermore, when transmitting the use history information Da, the history transmission control unit 27 transmits the use history information Da by associating it with user identification information Dc that identifies the user A. Note that the transmission timings and transmission intervals of the use history information Da can be set as appropriate.

FIG. 3 is a diagram showing a functional configuration of the recommendation server 10.

The recommendation server 10 is a computer that includes a processor, a memory device, a storage device, a communication device (receiver and transmitter) that communicates via the telecommunication line 4, and an interface circuit for connecting various kinds of peripheral devices.

Then, various kinds of functions related to providing the recommendation service are implemented through executing a computer program stored in the memory device or the storage device by the processor.

Specifically, as the functional configuration, the processor of the recommendation server 10 functions as an information collection unit 30, an aggregation unit 31, an aggregation result storage unit 32, a driver assistance function information storage unit 33, a prescribed area specification unit 34, a moving route acquisition unit 35, a user identification information acquisition unit 36, a recommended function/area specification unit 37, a recommendation unit 38, and an incentive giving unit 39.

The information collection unit 30 collects the use history information Da that is the information related to the use histories of the driver assistance functions in a plurality of vehicles 2. Specifically, the information collection unit 30 acquires the use history information Da transmitted at appropriate timings from each of the vehicles 2 via the communication device of the recommendation server 10.

The aggregation unit 31 aggregates the use history information Da collected from each of the vehicles 2 by the information collection unit 30. Specifically, the aggregation unit 31 aggregates, for each of the driver assistance functions, aggregated values of the used position information Da2 in each of the vehicles 2, aggregated values of the user evaluation information Da3 in each of the vehicles 2, and use frequencies in each of the vehicles 2.

Note that the aggregation unit 31 may aggregate the use frequency and the like for each time unit such as the used time zone or season, traveling states, traveling environments, and the like. Furthermore, the mode of aggregating the user evaluation information Da3 is determined as appropriate.

The aggregation result storage unit 32 stores the aggregation result F of the use history information Da acquired by the aggregation unit 31. The aggregation result F of the embodiment contains the use frequency, the aggregated value of the use position information Da2, the aggregated value of the user evaluation information Da3 for each of the driver assistance functions.

The driver assistance function information storage unit 33 stores in advance driver assistance function information J.

The driver assistance function information J is the information regarding various kinds of driver assistance functions available in the vehicle 2, and the driver assistance function information J of the embodiment contains, for each of the driver assistance functions, information of the area where the driver assistance function is expected to be used. As for the information of the area, position information and road link information can be used.

Furthermore, the area where the driver assistance function is expected to be used can be specified as follows.

For example, information collected by a specific vehicle actually driving on a road or information collected from a plurality of vehicles 2 may be analyzed/evaluated to specify the area where the driver assistance function is expected to be used (that is, the use thereof is effective for assisting the driver).

The information collected from the specific vehicle and the vehicles 2 may be information regarding the vehicle condition at the time of traveling (information regarding driving operations, car speeds, and the like), information regarding the traveling roads, and surrounding environment information (existence of obstacles, and the like) at the time of traveling, for example. As the source for such information, it is possible to use signals output from in-vehicle sensors, in-vehicle cameras, vehicle control ECUs, navigation devices, and the like loaded on the vehicles 2.

Furthermore, the method for analyzing/evaluating the information is determined as appropriate. For example, AI (Artificial Intelligence) may specify, for each of various kinds of driver assistance functions, the area where the driver assistance function is expected to be used based on the information collected from the specific vehicle and the vehicles 2 and past learning data.

The prescribed area specification unit 34 specifies the areas where the driver assistance function is expected to be used based on the driver assistance function information J and, among the areas, specifies a prescribed area where the aggregation result F corresponds to a prescribed condition.

The prescribed condition is a condition with which the use record of a plurality of vehicles 2 regarding the driver assistance function expected to be used in that area is considered poor, and it is defined in the embodiment that the use frequency (total number of use times) in a plurality of vehicles 2 in that area is a prescribed number or less.

That is, the prescribed area specification unit 34 specifies, based on the aggregation result F, the use frequency of the driver assistance function in each of the areas where the driver assistance function is expected to be used, and specifies the area where the use frequency is equals to or less than the prescribed number as the prescribed area.

The moving route acquisition unit 35 acquires the moving route E regarding the target user A1 (the user A who is operating the client device C) as the target for recommending the driver assistance function and the user identification information Dc of the target user A1. The moving route E is transmitted from the client device C based on an operation of the target user A1, and received by the communication device of the recommendation server 10. Thereby, the moving route acquisition unit 35 acquires the moving route E.

The user identification information acquisition unit 36 acquires the user identification information Dc of the target user A1 corresponding to the moving route E.

The recommended function/area specification unit 37 specifies a recommended area Dg and a recommended function Df based on the moving route E of the target user A1 and the prescribed area specified by the prescribed area specification unit 34.

The recommended area Dg is an area to be recommended to the target user A1 among the prescribed areas, and the recommended function Df is the driver assistance function recommended to be used in the recommended area Dg.

In the embodiment, the recommended function/area specification unit 37 specifies the prescribed areas where the moving route E passes through as the recommended areas Dg, and specifies the driver assistance functions corresponding to each of the recommended areas Dg as the recommended functions Df.

The recommendation unit 38 generates recommendation information Dh that is the information for recommending, to the target user A1, the recommended function Df and the recommended area Dg in an associated manner, and executes control for transmitting the recommendation information Dh to the client device C from the communication device.

The incentive giving unit 39 gives an incentive to the target user A1, when the target user A1 uses the recommended function Df recommended by the recommendation server 10. In addition, the incentive giving unit 39 additionally gives a same or different incentive, when the target user A1 makes an evaluation for the recommended function Df. Any specific modes may be used for the incentive, and examples thereof may be a service coupon, a discount coupon, a voucher, and a gift. Note that the incentive giving unit 39 may give an incentive when the target user A1 uses and evaluates the recommended function Df.

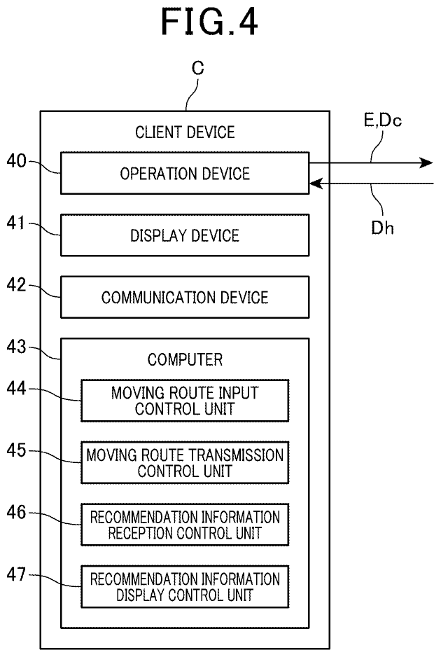

FIG. 4 is a diagram showing a functional configuration of the client device C.

The client device C is a device that receives recommendation of the recommended function Df from the recommendation server 10. Examples of the client device C may be a mobile device such as a smartphone or a laptop PC, a desktop PC, an in-vehicle device loaded on the vehicle 2 (FIG. 1) where the target user A1 is riding, or the like.

As shown in FIG. 4, the client device C includes an operation device 40, a display device 41, a communication device 42, and a computer 43.

The operation device 40 is a device that receives operations of the user A, and it is a button, a touch panel, or the like. The display device 41 is a device that displays various kinds of information. The communication device 42 is a device that communicates with the recommendation server 10 via the telecommunication line 4.

The computer 43 includes a processor, a memory device, a storage device, and an interface circuit for connecting various kinds of peripheral devices (the operation device 40, the display device 41, the communication device 42, and the like).

Then, various kinds of functions related to a client computer that receives the recommendation service are implemented through executing a computer program stored in the memory device or the storage device by the processor.

Specifically, as the functional configuration, the computer 43 includes a moving route input control unit 44, a moving route transmission control unit 45, a recommendation information reception control unit 46, and a recommendation information display control unit 47.

The moving route input control unit 44 executes control for receiving input of the moving route E from the target user A1 via the operation device 40.

The moving route transmission control unit 45 executes control for transmitting the moving route E to the recommendation server 10 from the communication device 42. Furthermore, when transmitting the moving route E, the moving route transmission control unit 45 associates it with the user identification information Dc of the target user A1.

The recommendation information reception control unit 46 executes control for receiving the recommendation information Dh from the recommendation server 10 by the communication device 42.

The recommendation information display control unit 47 executes control for displaying the information related to recommending the recommended function Df and the recommended area Dg on the display device 41 based on the recommendation information Dh. A specific mode of the display will be described later.

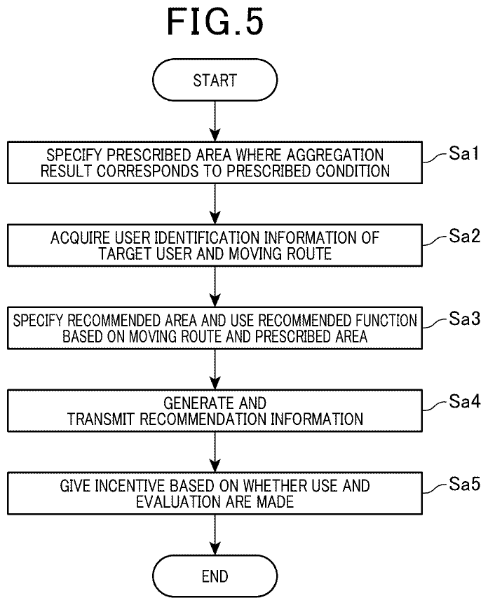

FIG. 5 is a flowchart showing an operation related to a recommendation for the target user A1 offered by the recommendation server 10.

Separately from the processing shown therein, collection of the use history information Da by the information collection unit 30 and aggregation by the aggregation unit 31 are executed sequentially in the recommendation server 10.

As shown in FIG. 5, when the recommendation server 10 offers an recommendation to the target user A1, the prescribed area specification unit 34 first specifies, among the areas where the driver assistance function is expected to be used, the areas where the use frequency of the driver assistance function is the prescribed number or less as the prescribed areas (Step Sa1).

Then, the moving route acquisition unit 35 acquires the moving route E, and the user identification information acquisition unit 36 acquires the user identification information Dc of the target user A1 (Step Sa2).

Note that Steps Sa1 and Sa2 may be executed in an arbitrary order.

Then, the recommended function/area specification unit 37 specifies the recommended areas Dg and the recommended functions Df based on the moving route E and the prescribed areas (Step Sa3). As described above, the recommended function/area specification unit 37 specifies the prescribed areas where the moving route E passes through as the recommended areas Dg, and specifies the driver assistance functions corresponding to each of the recommended areas Dg as the recommended functions Df.

Then, the recommendation unit 38 generates the recommendation information Dh for recommending the recommended areas Dg and the recommended functions Df in an associated manner, and transmits the recommendation information Dh to the client device C (Step Sa4). In the embodiment, the recommendation unit 38 generates the recommendation information Dh to include the information of incentives given for the use of and evaluation for the recommended functions Df.

The client device C shows display for providing a recommendation on the display device 41 based on the recommendation information Dh.

Thereafter, the incentive giving unit 39 determines whether the target user A1 has used the recommended function Df and has made user evaluation based on the use history information Da of the target user A1, and gives an incentive to the target user A1 in accordance with the determination result (Step Sa5). An incentive is given by the incentive giving unit 39 by recording, in incentive giving information Dk (FIG. 3), the target user A1 and the incentive to be given to the target user A1 in an associated manner.

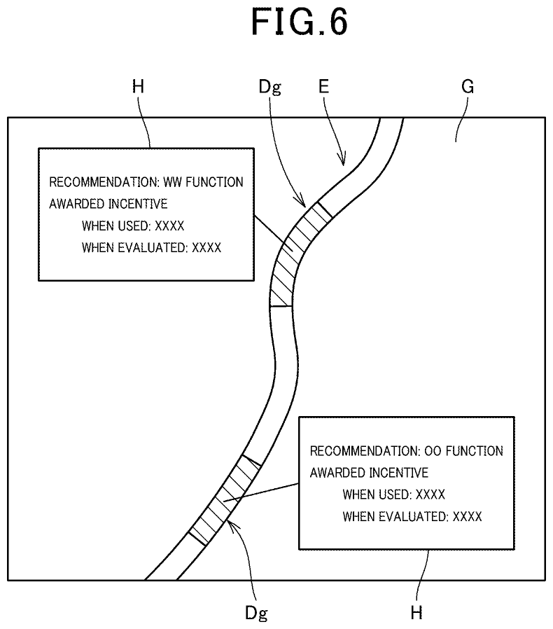

FIG. 6 is a diagram showing an example of the display based on the recommendation information Dh.

As shown therein, the recommended areas Dg and the recommended functions Df are recommended by the client device C by superimposing and displaying each piece of information contained in the recommendation information Dh on a map G that includes the moving route E. Note that the data source of the map G may be provided to the client device C, may be an adequate server computer, or the recommendation information Dh may contain the data of the map G.

The recommended areas Dg where the moving route E passes through are displayed in a mode (color, hatching, or the like) distinguishable from other routes, and information display sections H are displayed by being associated with respective recommended areas Dg. The information display section H is for displaying each piece of information contained in the recommendation information Dh, and the name (“recommendation” in the drawing) of the recommended function Df, and the incentives awarded due to the use of and evaluation for the recommended function Df are displayed in the embodiment.

With such a display, the target user A1 can grasp the recommended functions Df and the recommended areas Dg when moving on the moving route E by driving the vehicle 2, and effectively utilize the driver assistance functions for own driving.

Furthermore, since the incentives awarded to the target user A1 are displayed in the information display sections H, it is possible to encourage the target user A1 to use the recommended functions Df and to accumulate the use record of the recommended functions Df for the recommended areas Dg more quickly.

Following effects can be achieved by the embodiment.

The recommendation server 10 according to the embodiment is a device that recommends the driver assistance functions available for the user A who is driving the vehicle 2.

The recommendation server 10 includes: the information collection unit 30 that collects the use history information Da related to the use of the driver assistance function in a plurality of vehicles 2; the aggregation unit 31 that aggregates the use history information Da collected by the information collection unit 30; the prescribed area specification unit 34 that specifies, among the areas where the driver assistance function is expected to be used, the prescribed area where the aggregation result F acquired by the aggregation unit 31 corresponds to the prescribed condition; and the recommendation unit 38 that outputs the recommendation information Dh for recommending the prescribed area and the driver assistance function expected to be used in the prescribed area in an associated manner.

With such a configuration, for the recommended area Dg that is the prescribed area where the aggregation result F of the use history information Da collected from a plurality of vehicles corresponds to the prescribed condition, the recommended function Df that is the driver assistance function expected to be used therein is recommended to the target user A1.

Thereby, the prescribed area where there is only a poor use record of the driver assistance function in a plurality of vehicles can be recommended to the target user A1 as the recommended area Dg. Furthermore, such a recommendation can promote the use of the recommended function Df in the recommended area Dg, and the use record thereof can be accumulated.

The recommendation server 10 according to the embodiment includes the moving route acquisition unit 35 that acquires the moving route E of the vehicle 2 driven by the target user A1, and the recommended areas Dg recommended by the recommendation unit 38 are the areas the moving route E passes through.

With such a configuration, the target user A1 can grasp the recommended functions Df and the recommended areas Dg when moving on the moving route E by driving the vehicle 2, and effectively utilize the driver assistance functions for own driving.

In the recommendation server 10 according to the embodiment, the moving route E is a travel route in one cycle of past or future driving cycles of the vehicle 2.

With such a configuration, the target user A1 can do review and preparation of the recommended functions Df and the recommended areas Dg for the past travel routes or future travel routes.

The recommendation server 10 according to the embodiment includes the incentive giving unit 39 that gives an incentive to the target user A1, when the target user A1 uses the recommended function Df recommended by the recommendation information Dh.

With such a configuration, it is possible to encourage the target user A1 to use the recommended function Df and to accumulate the use record of the recommended Df for the recommended area Dg more quickly.

In the recommendation server 10 according to the embodiment, the incentive giving unit 39 gives an additional incentive when the target user A1 evaluates the recommended function Df.

With such a configuration, it is possible to encourage the target user A1 who has actually used the recommended function Df to make an evaluation thereof, and to accumulate the user evaluation for the recommended function Df.

Note that the embodiment described above is simply an example of one aspect of the present invention. That is, it is to be noted that any modifications and applications of the embodiment described above are possible without departing from the gist and scope of the present invention, and that each aspect related to the embodiment, modifications, and applications can be combined as appropriate.

In the embodiment described above, the recommendation server 10 does not need to have the server function for providing the recommendation service, but may be a recommendation device configured using a non-server computer.

Each of the drawings showing the functional configuration of the embodiment described above is a schematic view showing the structural elements classified in accordance with the main processing contents in order to facilitate understanding of the present invention, and the structural elements may be classified into a greater number of structural elements in accordance with the processing contents. Furthermore, classification may be made such that one structural element executes more kinds of processing.

### Configuration Supported by the Embodiment

The above-described embodiment supports the following items.

(Item 1) A recommendation device recommending a driver assistance function available for a user who is driving a vehicle, the recommendation device including: an information collection unit configured to collect information related to use of the driver assistance function in a plurality of the vehicles; an aggregation unit configured to aggregate the information related to the use collected by the information collection unit; a prescribed area specification unit configured to specify, among areas where the driver assistance function is expected to be used, a prescribed area where an aggregation result acquired by the aggregation unit corresponds to a prescribed condition; and a recommendation unit configured to output recommendation information that recommends the prescribed area and the driver assistance function expected to be used in the prescribed area in an associated manner.

According to item 1, it is possible to offer a recommendation for the area where there is only a poor use record of the driver assistance function in a plurality of vehicles.

(Item 2) The recommendation device according to item 1, including a moving route acquisition unit configured to acquire a moving route of the vehicle driven by a target user of the recommendation, in which the prescribed area recommended by the recommendation unit is an area where the moving route passes through.

According to item 2, the target user can grasp the driver assistance function recommended to be used and the prescribed area where the use thereof is recommended when moving on the moving route by driving the vehicle, and effectively utilize the driver assistance function for own driving.

(Item 3) The recommendation device according to item 2, in which the moving route is a travel route in one cycle of past or future driving cycles of the vehicle.

According to item 3, the target user can do review and preparation of the driver assistance function recommended to be used and the prescribed area where the use thereof is recommended for the past travel routes or the future travel routes.

(Item 4) The recommendation device according to any one of items 1 to 3, including an incentive giving unit configured to give an incentive to a target user of the recommendation, when the target user uses the driver assistance function recommended by the recommendation information.

According to item 4, it is possible to encourage the target user to use the driver assistance function and to accumulate the use record of the driver assistance function for the prescribed area more quickly.

(Item 5) The recommendation device according to item 4, in which the incentive giving unit gives the incentive, when the user evaluates the driver assistance function.

According to item 5, it is possible to encourage the target user to evaluate the driver assistance function and to accumulate the user evaluation for the driver assistance function.

(Item 6) A recommendation method used in a recommendation device that recommends a driver assistance function available for a user who is driving a vehicle, the recommendation method including: collecting information related to use of the driver assistance function in a plurality of the vehicles; aggregating the collected information related to the use; specifying, among areas where the driver assistance function is expected to be used, a prescribed area where an aggregation result of the information related to the use corresponds to a prescribed condition; and outputting recommendation information that recommends the prescribed area and the driver assistance function expected to be used in the prescribed area in an associated manner.

According to item 6, it is possible to offer a recommendation for the area where there is only a poor use record of the driver assistance function in a plurality of vehicles.

### REFERENCE SIGNS LIST

1 Recommendation system
2 Vehicle
10 Recommendation server (recommendation device)
22 Driver assistance device
30 Information collection unit
31 Aggregation unit
32 Aggregation result storage unit
33 Driver assistance function information storage unit
34 Prescribed area specification unit
35 Moving route acquisition unit
36 User identification information acquisition unit
37 Area specification unit
38 Recommendation unit
39 Incentive giving unit
A1 Target user A
Da Use history information
Da1 Used function information
Da2 Used position information
Da3 User evaluation information
Dc User identification information
Df Recommended function
Dg Recommended area
Dh Recommendation information
Dk Incentive giving information
E Moving route
F Aggregation result

What is claimed is:

1. A recommendation device recommending a driver assistance function available for a user who is driving a vehicle, the recommendation device comprising:
an information collection unit configured to collect information related to use of the driver assistance function in a plurality of the vehicles;
an aggregation unit configured to aggregate the information related to the use collected by the information collection unit;
a prescribed area specification unit configured to specify, among areas where the driver assistance function is expected to be used, a prescribed area where an aggregation result acquired by the aggregation unit corresponds to a prescribed condition; and
a recommendation unit configured to output recommendation information that recommends the prescribed area and the driver assistance function expected to be used in the prescribed area in an associated manner.

2. The recommendation device according to claim 1, comprising a moving route acquisition unit configured to acquire a moving route of the vehicle driven by a target user of the recommendation, wherein
the prescribed area recommended by the recommendation unit is an area where the moving route passes through.

3. The recommendation device according to claim 2, wherein the moving route is a travel route in one cycle of past or future driving cycles of the vehicle.

4. The recommendation device according to claim 1, comprising an incentive giving unit configured to give an incentive to a target user of the recommendation, when the target user uses the driver assistance function recommended by the recommendation information.

5. The recommendation device according to claim 4, wherein the incentive giving unit gives the incentive, when the user evaluates the driver assistance function.

6. A recommendation method used in a recommendation device that recommends a driver assistance function available for a user who is driving a vehicle, the recommendation method comprising:
collecting information related to use of the driver assistance function in a plurality of the vehicles;
aggregating the collected information related to the use;
specifying, among areas where the driver assistance function is expected to be used, a prescribed area where an aggregation result of the information related to the use corresponds to a prescribed condition; and
outputting recommendation information that recommends the prescribed area and the driver assistance function expected to be used in the prescribed area in an associated manner.
